(19) United States
(12) Patent Application Publication
(10) Pub. No.: US 2013/0154604 A1
(43) Pub. Date: Jun. 20, 2013

(54) REFERENCE CURRENT GENERATION CIRCUIT AND REFERENCE VOLTAGE GENERATION CIRCUIT

(71) Applicant: Seiko Instruments Inc., Chiba-shi (JP)

(72) Inventor: Masakazu SUGIURA, Chiba-shi (JP)

(73) Assignee: SEIKO INSTRUMENTS INC., Chiba-shi (JP)

(21) Appl. No.: 13/672,213

(22) Filed: Nov. 8, 2012

(30) Foreign Application Priority Data
Dec. 15, 2011 (JP) 2011-274640

(51) Int. Cl. G05F 3/24

(52) U.S. Cl. 323/313

(57) ABSTRACT

Provided are a reference current generation circuit and a reference voltage generation circuit, which have improved response speed when power supply is activated or fluctuates. In order to reduce a load capacitance of an operational amplifier, a transistor for providing a current to a transistor pair having a common gate-source voltage is provided, and the operational amplifier controls an ON-state resistance of the transistor.

### RELATED APPLICATIONS

This application claims priority under 35 U.S.C. §119 to Japanese Patent Application No. 2011-274640 filed on Dec. 15, 2011, the entire content of which is hereby incorporated by reference.

### BACKGROUND OF THE INVENTION

1. Field of the Invention

The present invention relates to a reference current generation circuit for generating a predetermined current and a reference voltage generation circuit using the reference current.

2. Description of the Related Art

Conventionally, as a reference voltage generation circuit having a function of generating a voltage having small temperature dependence, there is known a circuit for generating a voltage which is substantially equal to a bandgap value of silicon (see, for example, Japanese Patent Application Laid-open No. 2002-244748).

FIG. 6 is a configuration diagram illustrating a conventional reference voltage generation circuit. The conventional reference voltage generation circuit includes a reference current generation section including a PN junction 601, a PN junction 602, a resistor 603 having a resistance value R1, a transistor 604, a transistor 605, and an operational amplifier 609, and a reference voltage generation section including a transistor 606, a resistor 607 having a resistance value R3 which is of the same type and has the same temperature characteristic as the resistor 603 and a PN junction 608. The PN junction 601 and the PN junction 602 have a relationship in which an effective area ratio is 1:(K1).

The transistor 604 and the transistor 605 have the same gate-source voltage, and hence currents based on the size ratio flows therethrough. For example, when the size ratio is 1:1, substantially equal currents flow through the transistor 604 and the transistor 605. The operational amplifier 609 controls an ON-state resistance of the two transistors of the transistor 604 and the transistor 605 so that VA and VB may be equal to each other, to thereby control a current Ibias flowing through the transistor 604 and the transistor 605 to a predetermined value. In this case, the constant current Ibias flowing through the transistor 604 and the transistor 605 is expressed by Expression (1).

Ibias=VT×{ln(K1)}/R1 (1)

where VT is a thermal voltage and is represented by kT/q. Note that, q represents a unit electronic charge, k represents a Boltzmann's constant, and T represents an absolute temperature.

A current obtained by mirroring the current Ibias flows through the transistor 606. When the size ratio between the transistor 604 and the transistor 606 is, for example, 1:1, and a difference voltage generated at the PN junction 608 is represented by Vpn3, a reference voltage Vref is expressed by Expression (2).

Vref=Vpn3+(R3/R1)×VT×{ln(K1)} (2)

The first term exhibits a negative temperature characteristic because Vpn3 has a negative temperature characteristic of about −2.0 mV/° C. The second term exhibits a positive temperature characteristic because the thermal voltage VT has a positive temperature characteristic.

Expression (2) is differentiated with respect to T, and the condition in which Vref becomes zero is obtained as expressed by Expression (3).

(R3/R1)×(k/q)×{ln(K1)}=0.002 (3)

Therefore, when Vpn3 is about 0.65 V at room temperature, merely by setting (R3/R1) so as to satisfy Expression (3), the reference voltage Vref of about 1.25 V can be obtained.

In this manner, a reference voltage generation circuit having a function of generating a voltage having small temperature dependence can be obtained.

By the way, in Expression (1), if R1 is set to have the same temperature characteristic as the thermal voltage VT, the current Ibias has small temperature dependence. In other words, a reference current generation circuit having a function of generating a current having small temperature dependence can be obtained.

In the conventional reference voltage generation circuit, however, when power supply is activated or power supply fluctuates, that is, when a power supply VDD fluctuates in a pulse manner and the internal operating point fluctuates, the input capacitances of the two transistors of the transistor 604 and the transistor 605 are present as a load capacitive element of the operational amplifier 609. Therefore, there has been a problem in that it takes time for the operating point to converge and return to the original one.

In other words, when the load capacitance to be driven by the operational amplifier 609 is large, the large amplitude response and the small signal response of the operational amplifier 609 are deteriorated, and hence it takes time to converge and return to the original operating point.

### SUMMARY OF THE INVENTION

The present invention has been made in order to solve the above-mentioned problem, and realizes a reference current generation circuit and a reference voltage generation circuit using the same, which have improved response speed when power supply is activated or fluctuates without sacrificing their required function.

A reference current generation circuit according to the present invention includes: a plurality of PN junctions; a transistor pair having a common gate-source voltage for providing a current to the plurality of PN junctions; and a transistor for providing a current to the transistor pair having the common gate-source voltage. The reference current generation circuit is therefore a constant current generation circuit for generating a constant current having small temperature dependence.

Further, a reference voltage generation circuit according to the present invention uses the above-mentioned constant current to generate a reference voltage having small temperature dependence.

According to the reference voltage generation circuit of the present invention, it is possible to provide a constant current circuit and a reference voltage generation circuit which are capable of reducing a load capacitance of an operational amplifier and improving response speed when power supply is activated or fluctuates without sacrificing their required function.

### BRIEF DESCRIPTION OF THE DRAWINGS

In the accompanying drawings:

FIG. 1 is a configuration diagram illustrating a reference current generation circuit according to an embodiment of the present invention;

FIG. 2 is a configuration diagram illustrating a reference current generation circuit according to another embodiment of the present invention;

FIG. 3 is a configuration diagram illustrating a reference voltage generation circuit according to still another embodiment of the present invention;

FIG. 4 is a configuration diagram illustrating a reference voltage generation circuit according to further another embodiment of the present invention;

FIG. 5 is a configuration diagram illustrating a reference voltage generation circuit according to further another embodiment of the present invention; and

FIG. 6 is a configuration diagram illustrating a conventional reference voltage generation circuit.

### DETAILED DESCRIPTION OF THE PREFERRED EMBODIMENTS

Referring to the accompanying drawings, a reference current generation circuit and a reference voltage generation circuit according to the present invention are described below.

### First Embodiment

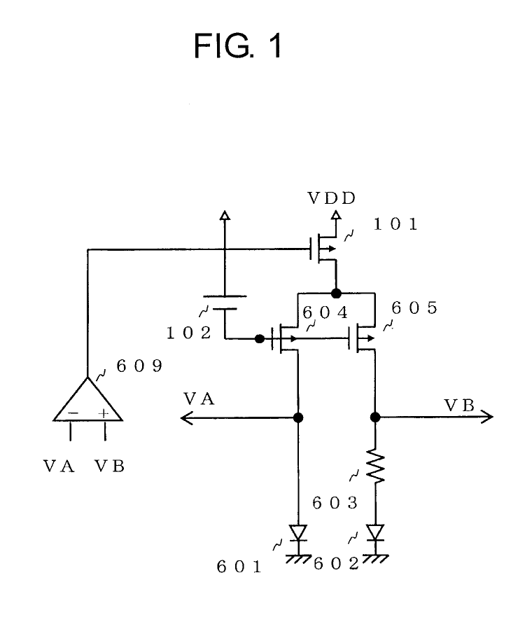

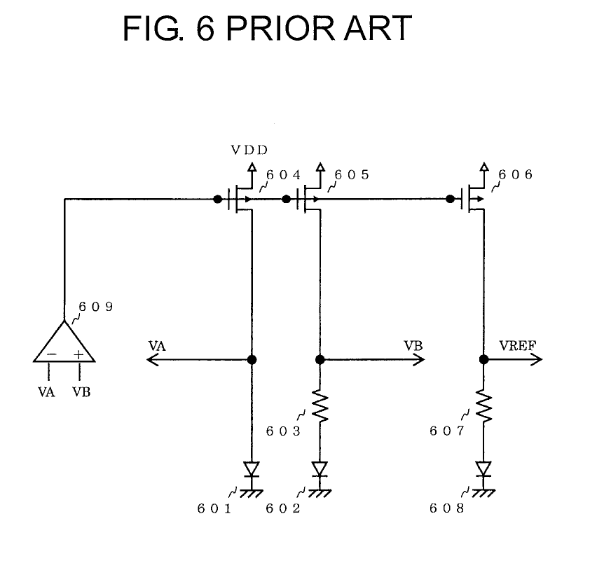

FIG. 1 is a configuration diagram illustrating a reference current generation circuit according to a first embodiment of the present invention. A reference current generation section of FIG. 1 is different from that in FIG. 6 in that a transistor 101 for providing a current to a transistor pair of the transistor 604 and the transistor 605, and a voltage source 102 are newly added. Other configurations are similar to FIG. 6. The reference current generation section includes the PN junction 601, the PN junction 602, the resistor 603 having the resistance value R1, the transistor 604, the transistor 605, and the operational amplifier 609. The PN junction 601 and the PN junction 602 have a relationship in which an effective area ratio is 1:(K1). It is herein assumed that R1 has the same temperature characteristic as the thermal voltage VT. An output of the operational amplifier 609 is connected to a gate of the transistor 101. In FIG. 6, the input capacitances of the two transistors of the transistor 604 and the transistor 605 are present as a load capacitive element of the operational amplifier 609. In this embodiment, however, the load capacitive element is replaced by the transistor 101 alone, and hence the load capacitance of the operational amplifier 609 is reduced. The voltage source 102 is connected to gates of the transistor 604 and the transistor 605. The voltage source 102 uses, for example, a gate-source voltage generated when a constant current is provided to a saturation-connected transistor.

Now, the operation of the reference current generation circuit in this embodiment is described.

The transistor pair of the transistor 604 and the transistor 605 has the same gate-source voltage, and hence currents based on the size ratio flow therethrough. Supposing that the size ratio is 1:1 for simplification, substantially equal currents flow through the transistor 604 and the transistor 605. The operational amplifier 609 controls an ON-state resistance of the transistor 101 so that voltages of VA and VB are equal to each other. The transistor 101 provides a current to the transistor pair of the transistor 604 and the transistor 605, and hence, when the ON-state resistance of the transistor 101 is controlled, a current Ibias flowing through the transistor 604 and the transistor 605 is controlled to a predetermined value. In other words, the operational amplifier 609 controls the current Ibias flowing through the transistor 604 and the transistor 605 to a predetermined value so that the voltages of VA and VB are equal to each other. The current Ibias is therefore expressed by Expression (1) similarly to the background art.

Ibias=VT×{ln(K1)}/R1 (1)

Accordingly, a current flowing through the transistor 101 is 2×Ibias. R1 has the same temperature characteristic as the thermal voltage VT, and hence the current Ibias has small temperature dependence. In other words, a reference current generation circuit having the function of generating a current having small temperature dependence can be obtained. Besides, by providing an additional transistor having the same gate-source voltage as the transistor 101, the current Ibias can be current-mirrored and used.

According to the reference current generation circuit in this embodiment, the load capacitance of the operational amplifier 609 is reduced, and hence, when power supply is activated or power supply fluctuates, that is, when a power supply VDD fluctuates in a pulse manner and the internal operating point fluctuates, the time period necessary for the operating point to converge and return to the original one can be shortened.

Therefore, a reference current generation circuit having small temperature dependence and having improved response speed when power supply is activated or fluctuates can be obtained.

### Second Embodiment

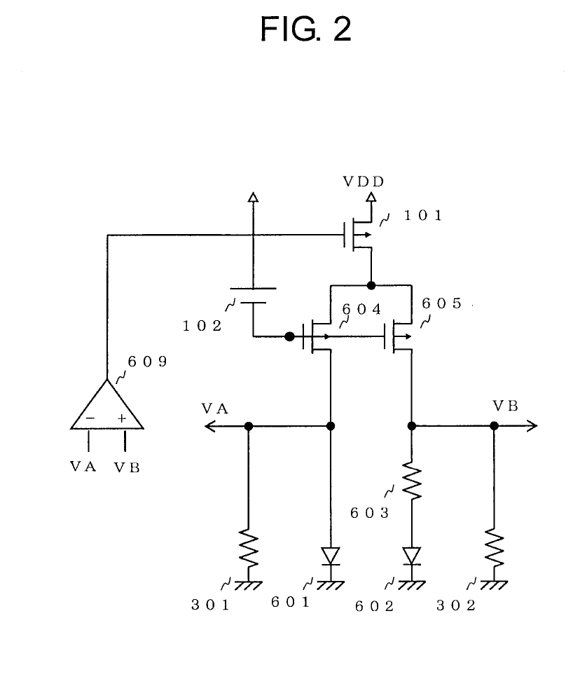

FIG. 2 is a configuration diagram illustrating a reference current generation circuit according to a second embodiment of the present invention. FIG. 2 is different from FIG. 1 in that a resistor 301 and a resistor 302 are newly added. It is herein assumed that the resistor 301 and the resistor 302 in particular are of the same type and have the same temperature characteristic, whose resistance values R2 are equal to each other. A difference voltage generated in the PN junction 601 is represented by Vpn1.

Now, the operation of the reference current generation circuit in this embodiment is described.

The basic operation is the same as in the first embodiment, but a current of the resistor 301 is added to the current to be driven by the transistor 604.

Ibias is expressed by Expression (4).

Ibias=(Vpn1/R2)+VT×{ln(K1)}/R1 (4)

The first term exhibits a negative temperature characteristic because Vpn1 has a negative temperature characteristic of about −2.0 mV/° C. The second term exhibits a positive temperature characteristic because the thermal voltage VT has a positive temperature characteristic.

Therefore, in Expression (4), merely by setting R1 and R2 so that the sum of the first term and the second term has smaller temperature dependence, the current Ibias having smaller temperature dependence is obtained. In other words, a reference current generation circuit having the function of generating a current having small temperature dependence can be obtained. For example, by providing an additional transistor having the same gate-source voltage as the transistor 101, the current Ibias can be current-mirrored and used.

According to the reference current generation circuit in this embodiment, the load capacitance of the operational amplifier 609 is reduced, and hence, when power supply is activated or power supply fluctuates, that is, when the power supply VDD fluctuates in a pulse manner and the internal operating point fluctuates, the time period necessary for the operating point to converge and return to the original one can be shortened.

Therefore, a reference current generation circuit having small temperature dependence and having improved response speed when power supply is activated or fluctuates can be obtained.

### Third Embodiment

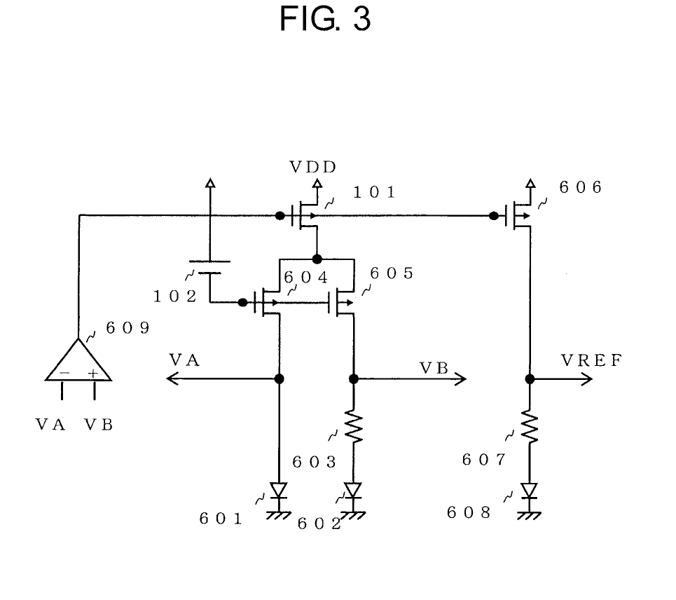

FIG. 3 is a configuration diagram illustrating a reference voltage generation circuit according to a third embodiment of the present invention, illustrating a reference voltage generation circuit using the reference current generation circuit of the first embodiment. FIG. 3 is different from FIG. 1 in that a reference voltage generation section including a transistor 606 having the same gate-source voltage as the transistor 101, a resistor 607 having a resistance value R3, and a PN junction 608 is added.

Now, the operation of the reference voltage generation circuit in this embodiment is described.

The circuit related to the generation of the current Ibias is the same as in the first embodiment, and hence the current Ibias is expressed by Expression (1).

The transistor 606 has the same gate-source voltage as the transistor 101, and hence a current based on 2×Ibias flows through the transistor 606. Supposing that the size ratio between the transistor 101 and the transistor 606 is, for example, 1:1, the current flowing through the transistor 606 is 2×Ibias.

When a difference voltage generated in the PN junction 608 is represented by Vpn3, a reference voltage Vref is expressed by Expression (5).

Vref=Vpn3+2×(R3/R1)×VT×{ln(K1)} (5)

The first term exhibits a negative temperature characteristic because Vpn3 has a negative temperature characteristic of about −2.0 mV/° C. The second term exhibits a positive temperature characteristic because the thermal voltage VT has a positive temperature characteristic.

Expression (5) is differentiated with respect to T, and the condition in which Vref becomes zero is obtained as expressed by Expression (6).

2×(R3/R1)×(k/q)×{ln(K1)}=0.002 (6)

Therefore, when Vpn3 is about 0.65 V at room temperature, merely by setting (R3/R1) so as to satisfy Expression (6), the reference voltage Vref of about 1.25 V is obtained.

The reference voltage Vref is obtained to have small temperature dependence, and hence a reference voltage generation circuit having the function of generating a voltage having small temperature dependence can be obtained.

In the reference voltage generation circuit in this embodiment, the load capacitance of the operational amplifier 609 is reduced, and hence, when power supply is activated or power supply fluctuates, that is, when the power supply VDD fluctuates in a pulse manner and the internal operating point fluctuates, the time period necessary for the operating point to converge and return to the original one can be shortened.

Therefore, a reference voltage generation circuit having small temperature dependence and having improved response speed when power supply is activated or fluctuates can be obtained.

### Fourth Embodiment

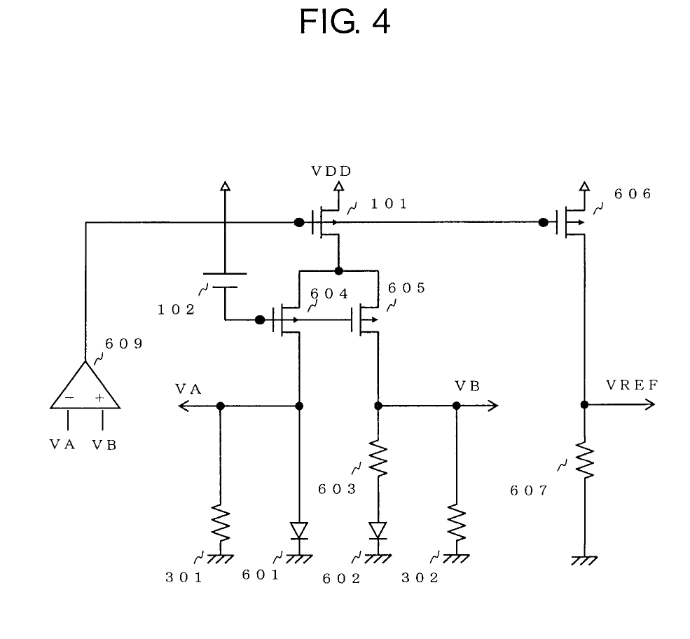

FIG. 4 is a configuration diagram illustrating a reference voltage generation circuit according to a fourth embodiment of the present invention, illustrating a reference voltage generation circuit using the reference current generation circuit of the first embodiment. FIG. 4 is different from FIG. 2 in that a reference voltage generation section including a transistor 606 having the same gate-source voltage as the transistor 101 and a resistor 607 is newly added. It is herein assumed that the resistor 607 in particular is of the same type and has the same temperature characteristic as the resistor 603, the resistor 301, and the resistor 302, and has a resistance value R3.

Now, the operation of the reference voltage generation circuit in this embodiment is described.

A current flowing through the transistor 101 is 2×Ibias.

A current based on 2×Ibias flows through the transistor 606. Supposing that the size ratio between the transistor 101 and the transistor 606 is, for example, 1:1, the current flowing through the transistor 606 is 2×Ibias.

A reference voltage Vref is expressed by Expression (7).

Vref=2×{(Vpn1/R2)+VT×{ln(K1)}/R1}×R3 (7)

Vref=2×R3/R2×Vpn1+2×VT×{ln(K1)}×R3/R1 (8)

The first term exhibits a negative temperature characteristic because Vpn1 has a negative temperature characteristic of about −2.0 mV/° C. The second term exhibits a positive temperature characteristic because the thermal voltage VT has a positive temperature characteristic.

Expression (8) is differentiated with respect to T, and the condition in which Vref becomes zero is obtained as expressed by Expression (9).

(R2/R1)×(k/q)×{ln(K1)}=0.002 (9)

Therefore, when Vpn1 is about 0.65 V at room temperature, merely by setting (R2/R1) so as to satisfy Expression (9), the reference voltage Vref is substantially expressed by Expression (10).

Vref=2×(R3/R2)×1.25 (10)

According to Expression (10), merely by setting (R3/R2), the absolute value of the reference voltage Vref can be freely obtained so as to have small temperature dependence.

Therefore, the reference voltage Vref is obtained to have small temperature dependence, and hence a reference voltage generation circuit having the function of generating a voltage having small temperature dependence can be obtained.

In the reference voltage generation circuit in this embodiment, the load capacitance of the operational amplifier 609 is reduced, and hence, when power supply is activated or power supply fluctuates, that is, when the power supply VDD fluctuates in a pulse manner and the internal operating point fluctuates, the time period necessary for the operating point to converge and return to the original one can be shortened.

Therefore, a reference voltage generation circuit having small temperature dependence and having improved response speed when power supply is activated or fluctuates can be obtained.

### Fifth Embodiment

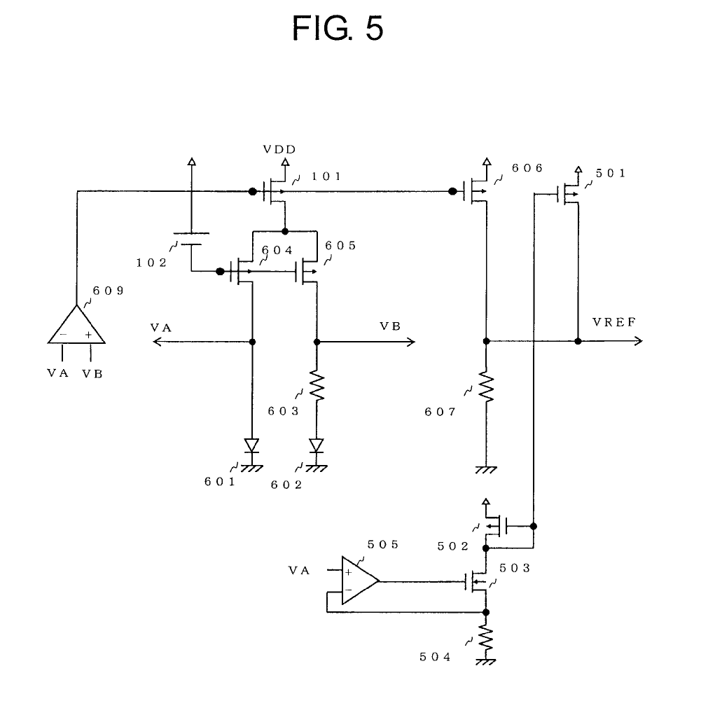

FIG. 5 is a configuration diagram illustrating a reference voltage generation circuit according to a fifth embodiment of the present invention, illustrating a reference voltage generation circuit using the reference current generation circuit of the first embodiment. FIG. 5 is different from FIG. 1 in that a transistor 606 having the same gate-source voltage as the transistor 101, a resistor 607 having a resistance value R3, a transistor 501, a transistor 502, a transistor 503, a resistor 504, and an operational amplifier 505 are newly added. It is herein assumed that the resistor 504 in particular is of the same type and has the same temperature characteristic as the resistor 603 and the resistor 607, and has a resistance value R5. The voltage VA is input to a non-inverting input terminal of the operational amplifier 505, but the voltage VB may be input thereto instead.

Now, the operation of the reference voltage generation circuit in this embodiment is described.

A current flowing through the transistor 101 is 2×Ibias. The current Ibias is expressed by Expression (1) similarly to the first embodiment.

A current based on 2×Ibias flows through the transistor 606. Supposing that the size ratio between the transistor 101 and the transistor 606 is, for example, 1:1, the current flowing through the transistor 606 is 2×Ibias.

Further, a current obtained by subjecting the difference voltage Vpn1 generated in the PN junction 601 to impedance conversion and dividing the resultant by R5 flows through the resistor 504. If the size ratio between the transistor 501 and the transistor 502 is, for example, 2:1, a current flowing through the transistor 501 is 2×(Vpn1/R5).

Therefore, the reference voltage Vref is expressed by Expression (11).

Vref=2×[(Vpn1/R5)+VT×{ln(K1)}/R1]×R3 (11)

Expression (11) is simplified to obtain Expression (12).

Vref=2×(R3/R5)×[Vpn1+VT×{ln(K1)}×(R5/R1)] (12)

The first term exhibits a negative temperature characteristic because Vpn1 has a negative temperature characteristic of about −2.0 mV/° C. The second term exhibits a positive temperature characteristic because the thermal voltage VT has a positive temperature characteristic.

Expression (12) is differentiated with respect to T, and the condition in which Vref becomes zero is obtained as expressed by Expression (13).

(R5/R1)×(k/q)×{ln(K1)}=0.002 (13)

Therefore, when Vpn1 is about 0.65 V at room temperature, merely by setting (R5/R1) so as to satisfy Expression (13), the reference voltage Vref is substantially expressed by Expression (14) so as to have small temperature dependence.

Vref=2×(R3/R5)×1.25 (14)

According to Expression (14), merely by setting (R3/R5), the absolute value of the reference voltage Vref can be freely obtained so as to have small temperature dependence.

Therefore, the reference voltage Vref is obtained to have small temperature dependence, and hence a reference voltage generation circuit having the function of generating a voltage having small temperature dependence can be obtained.

According to the reference voltage generation circuit in this embodiment, the load capacitance of the operational amplifier 609 is reduced, and hence, when power supply is activated or power supply fluctuates, that is, when the power supply VDD fluctuates in a pulse manner and the internal operating point fluctuates, the time period necessary for the operating point to converge and return to the original one can be shortened.

Therefore, a reference voltage generation circuit having small temperature dependence and having improved response speed when power supply is activated or fluctuates can be obtained.

Note that, in the above description in the first to fifth embodiments, the PN junction may be a bipolar transistor, a diode element, or other elements, and may be selected as appropriate. The use of a bipolar transistor leads to an advantage that a bipolar transistor present in a CMOS process in a parasitic manner can be utilized. Alternatively, in the case where a parasitic diode element is present in the CMOS process, it leads to a similar advantage that the diode element can be utilized.

Note that, a transistor that operates in the weak inversion region has an exponential relationship between voltage and current similarly to the PN junction, and hence the PN junction described in the above-mentioned first to fifth embodiments may be replaced by a transistor that operates in the weak inversion region. In this case, the need to use the PN junction can be eliminated, and hence the number of elements used can be reduced, thus leading to the cost advantage.

What is claimed is:

1. A reference current generation circuit, comprising:
a first PN junction;
a first transistor for causing a current to flow through the first PN junction;
a first resistor and a second PN junction connected in series;
a second transistor for causing a current to flow through the first resistor and the second PN junction;
a first voltage source for supplying a common voltage to gates of the first transistor and the second transistor;
a first operational amplifier including a first input terminal for inputting a voltage generated in the first PN junction and a second input terminal for inputting a voltage generated in the first resistor and the second PN junction; and
a third transistor including a gate controlled by an output voltage of the first operational amplifier, for supplying a current to the first transistor and the second transistor.

2. A reference current generation circuit according to claim 1, further comprising:
a second resistor connected in parallel to the first PN junction; and
a third resistor connected in parallel to the first resistor and the second PN junction.

3. A reference voltage generation circuit, comprising:
the reference current generation circuit according to claim 1;
a fourth resistor and a third PN junction connected in series; and
a fourth transistor including a gate connected in common to the gate of the third transistor, for causing a current to flow through the fourth resistor and the third PN junction.

4. A reference voltage generation circuit, comprising:
the reference current generation circuit according to claim 2;
a fourth resistor; and
a fourth transistor including a gate connected in common to the gate of the third transistor, for causing a current to flow through the fourth resistor.

5. A reference voltage generation circuit, comprising:
the reference current generation circuit according to claim 1;
a fourth resistor;
a fourth transistor including a gate connected in common to the gate of the third transistor, for causing a current to flow through the fourth resistor;
a fifth transistor and a fifth resistor connected in series;
a second operational amplifier including a first input terminal connected to a connection node between the fifth transistor and the fifth resistor, a second input terminal connected to one of the first input terminal and the second input terminal of the first operational amplifier, and an output terminal connected to a gate of the fifth transistor; and
a current-mirror circuit for causing a current of the fifth transistor to flow through the fourth resistor.
